(19) United States
(12) Patent Application Publication
(10) Pub. No.: US 2026/0023803 A1
(43) Pub. Date: Jan. 22, 2026

(54) UPDATING A GRAPHICAL USER INTERFACE OF A COMPUTER-EXECUTABLE APPLICATION TO PREVENT FRAUDULENT REPORTING

(71) Applicant: Manifold Cloud Services, LLC, Mogadore, OH (US)

(72) Inventors: James LaMont Bergmann, Mogadore, OH (US); Robert J. Bonitati, Cuyahoga Falls, OH (US)

(21) Appl. No.: 19/272,835

(22) Filed: Jul. 17, 2025

Related U.S. Application Data
(60) Provisional application No. 63/672,705, filed on Jul. 17, 2024.

(51) Int. Cl. G06F 16/955; G06F 16/909; G06F 16/957; H04W 4/029

(52) U.S. Cl. CPC G06F 16/9554; G06F 16/909; G06F 16/9577; H04W 4/029

(57) ABSTRACT

Technologies described herein relate to updating a graphical user interface of an application to prevent fraudulent reporting. A request to initiate an application installed on a client computing device is received, where the application is to be used in connection with performance of a service at a location that has an address. The application is initiated in response to receipt of the request. Location data from a location sensor on the client computing device is received. The address and/or geolocation coordinates of the location is accepted based upon the location data. A GUI is generated for the application, where the GUI includes data related to the service performed at the location and the address and/or geolocation coordinates of the location. The GUI is displayed on a display of the client computing device, such that a screenshot of the GUI includes the address and/or geolocation coordinates of the location.

### RELATED APPLICATION

This application claims priority to U.S. Provisional Patent Application No. 63/672, 705, filed on Jul. 17, 2024, and entitled “UPDATING A GRAPHICAL USER INTERFACE OF A COMPUTER-EXECUTABLE APPLICATION TO PREVENT FRAUDULENT REPORTING,” the entirety of which is incorporated herein by reference.

### BACKGROUND

There are various computer-implemented applications that assist users (e.g., heating, ventilation, and air conditioning (HVAC) installers) in analyzing aspects related to a structure (e.g., a home, a building, etc.). For example, but not by limitation, HVAC installers use an HVAC application to analyze characteristics of an HVAC system, such as the pressure and temperature of refrigerant in the HVAC system, force of airflow through the system, energy usage of the system, and the like. A report can be generated that includes measurements allegedly made by a user of the HVAC application, where the measurements can be reviewed by a property owner, a governmental agency that monitors energy usage, or the like. It is common for a technician using the HVAC system to include screenshots of the HVAC application in the report to provide evidence that the measurements included in the report were actually made by the technician and through use of the application.

It has been observed, however, that a technician may include screenshots in reports that are not related to an HVAC system that was to be serviced by the technician. For example, the technician may have several appointments during a single day, where the appointments include a first appointment at a first location followed by a second appointment at a second location. The technician may experience unexpected difficulties at the first appointment, causing the first appointment to take more time to complete than anticipated (and scheduled). To make up for the lost time, the technician may generate a fraudulent report, where the fraudulent report includes a screenshot of a previously-generated screenshot of the user interface of the HVAC application. With more specificity, during the first appointment at the first location, the technician may cause a mobile telephone to generate a screenshot of the GUI of the HVAC application, where the screenshot illustrates that certain measurements regarding an HVAC system were obtained. Thereafter, the technician may travel to the second location of the second appointment; rather than actually obtaining measurements of an HVAC system at the second location, however, the technician may copy measurements from the first appointment, bring up the screenshot of the GUI of the HVAC generated at the first location, and then take a new screenshot of that screenshot. The technician will then include the new screenshot in the report for the second appointment. The new screenshot will have geographical coordinates of the second location in metadata of the new screenshot; however, the technician did not properly service the HVAC system at the second location. There are currently no suitable technologies for preventing this type of fraudulent behavior.

### SUMMARY

The following is a brief summary of subject matter that is described in greater detail herein. This summary is not intended to be limiting as to the scope of the claims.

Various technologies are described herein that pertain to preventing a technician from generating a report that includes fraudulent screenshots of a computer-executable application (such as an HVAC application used by technicians when servicing HVAC systems). As will be described in greater detail below, the technologies described herein are directed towards updating a graphical user interface (GUI) of an application to include a unique identifier (such as a physical address or geographic coordinates) when a mobile computing device that executes the application is at a location of an appointment. Accordingly, when a screenshot is taken of the GUI of the application, geographic coordinates in metadata assigned to the screenshot will correspond to the unique identifier included in the GUI. This facilitates prevention of fraudulent reports being generated; for instance, if a technician were to generate a new screenshot based upon a screenshot obtained at a different location, the geographic coordinates in the metadata assigned to the new screenshot will differ from the unique identifier (physical address or geographic coordinates) in the GUI captured in the new screenshot.

In an example, a technician has multiple appointments during a day, where the appointments include a first appointment at a first location and a second appointment at a second location. Upon arriving at the first location for the first appointment, an HVAC application is initiated on a mobile computing device used by the technician. A Global Positioning System (GPS) sensor of the mobile computing device outputs location data that is indicative of a current location of the mobile computing device, and such location data is provided to the HVAC application. The HVAC application (optionally through a plug-in) determines a physical address based upon the location data and presents the physical address to the technician for confirmation. When the physical address corresponds to the first location of the first appointment, the technician confirms the physical address and the HVAC application accepts the address; when the physical address is incorrect (i.e., the physical address does not match the address of the first appointment), the technician can manually enter the correct address. The HVAC application compares the manually-entered physical address with the location data, and the HVAC application accepts the manually-entered physical address when the manually-entered physical address is within a threshold distance of the location data (e.g., 100 feet). When, however, the manually-entered physical address is not within the threshold distance of the location data, the HVAC system fails to accept the manually-entered physical address.

The HVAC application is then employed in connection with obtaining measurements of the HVAC system at the first location; a GUI of the HVAC application is shown on a display of the mobile computing device, where the GUI depicts measurements pertaining the HVAC system (e.g., measurements related to pressure, temperature, etc.). In addition, the GUI of the HVAC application is updated to include the address accepted by the HVAC application. Upon receipt of a command from the technician, the mobile computing device can generate a screenshot of the GUI, where the screenshot includes the aforementioned address. The mobile computing device can receive location data from the GPS sensor when the screenshot is generated and can include the location data as metadata that is assigned to the screenshot. The screenshot of the GUI may then be included in a report for the first appointment. Importantly, the address shown in the screenshot corresponds to the location data in the metadata.

Upon completing service at the first location, the technician travels to the second location to service a second HVAC system at the second location. If the technician were to attempt to display the screenshot on a display of the mobile computing device and cause the mobile computing device to generate a new screenshot for inclusion in a report for the second appointment, the new screenshot would still depict the address corresponding to the first location and not the second location. Hence, the technician is unable to fraudulently include an improper screenshot in a report for the second appointment. Moreover, if the technician attempted to modify the address in the screenshot through use of an image editing tool, metadata assigned to the screenshot would indicate that the screenshot was subject to modification.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of a client computing device that displays a graphical user interface (GUI) of an application, where the GUI of the application includes a location-based identifier.

FIG. 2 depicts a GUI of an HVAC application.

FIGS. 3-5 depict GUIs of an HVAC application, where the GUIs includes location-based identifiers.

FIG. 6 is a functional block diagram of the application of FIG. 1 including a GUI generator module according to various embodiments.

FIG. 7 is flow diagram depicting a method pertaining to displaying GUI of an application, where the GUI of the application includes a location-based identifier.

FIG. 8 is a schematic of a computing device.

### DETAILED DESCRIPTION

Various technologies pertaining to fraud prevention in connection with HVAC maintenance or other type of service provided by a service provider are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. Thus, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “module”, and “system” are intended to encompass computer-readable data storage that is configured with computer-executable instructions that cause certain functionality to be performed when executed by a processor. The computer-executable instructions may include a routine, a function, or the like. It is also to be understood that a component, module, or system may be localized on a single device or distributed across several devices. Further, as used herein, the term “exemplary” is intended to mean serving as an illustration or example of something and is not intended to indicate a preference.

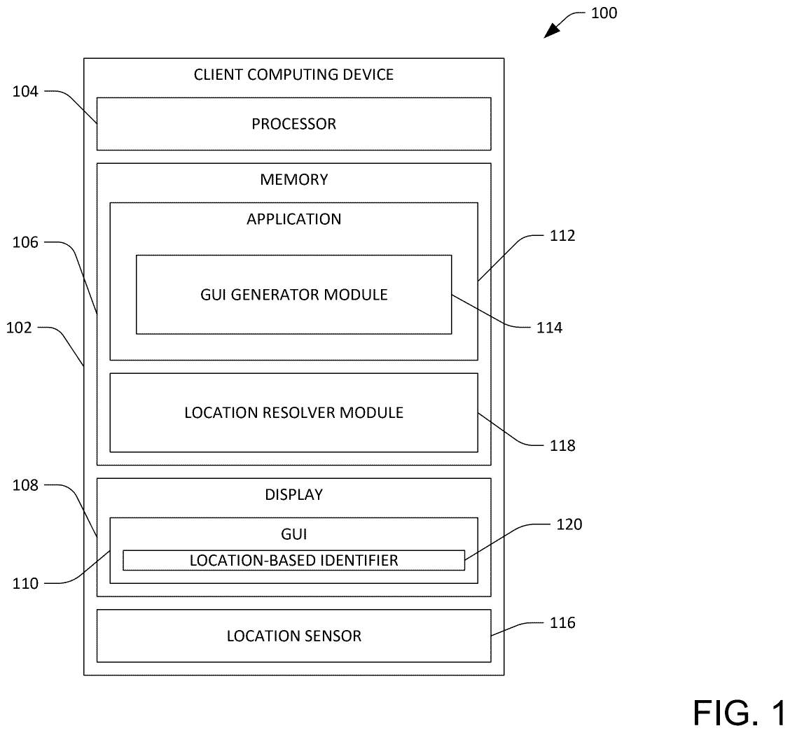

With reference to FIG. 1, a functional block diagram of a computing system 100 is illustrated. The system 100 includes a client computing device 102, where the client computing device 102 includes a processor 104 and memory 106, and further where the memory 106 stores instructions that are executed by the processor 104. The client computing device 102 can be any suitable mobile type of client computing device, such as a laptop computer, a tablet (slate) computing device, a virtual reality or augmented reality computing system, a mobile telephone, etc. The client computing device 102 also has a display 108 that displays content to a user of the client computing device 102. The display 108 can be a touch-sensitive display, although the technologies described herein are not so limited.

The memory 106 includes an application 112 that is executed by the processor 104. The application 112 is configured for use by service providers who provide services at different locations at different times; example service providers include HVAC technicians, appliance repair technicians, lawn service providers, piano tuners, electricians, pest control providers, insurance inspectors, and so forth. In the examples set forth herein, the application 112 is configured for use by HVAC technicians, where the application 112 configured to obtain measurements relating to HVAC systems, such as the pressure and temperature of refrigerant in the HVAC system, force of airflow through the system, energy usage of the system, and the like. However, the examples set forth herein can be extended to scenarios where the application 122 is configured for use by service providers in other service industries who provide other types of services at different locations at different times.

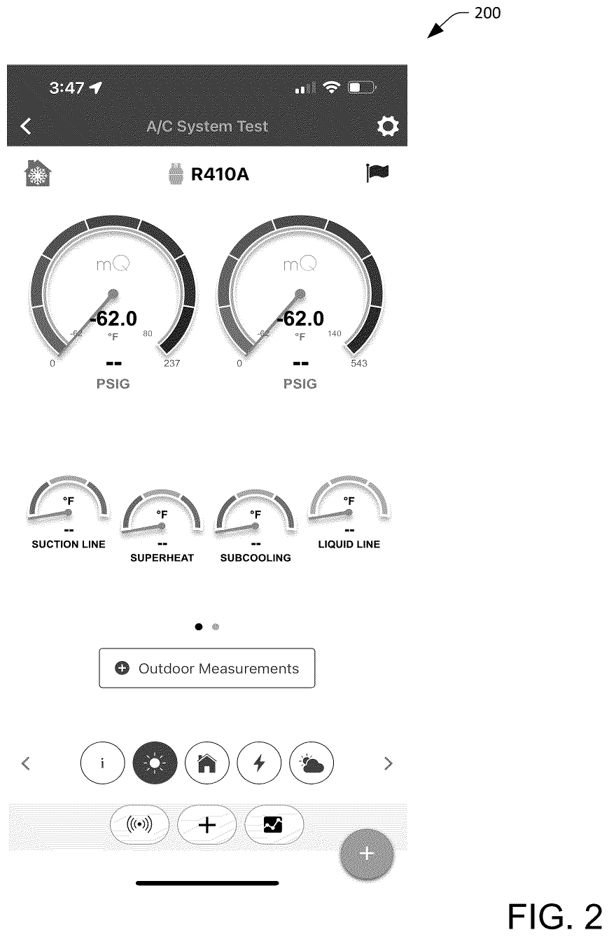

The application 112 has a GUI generator module 114 that is configured to cause a GUI 110 of the application 112 to be displayed on the display 108. Referring briefly to FIG. 2, an example of the GUI 110 of the application 112 is shown. Specifically, the GUI 110 depicts the results of an A/C System Test, where during the A/C System Test the application 112 obtains various measurements related to an HVAC system, such as values for pressure and temperature related to the HVAC system. The HVAC application 112 may be configured to assist the technician with performance of other tests, such as checking the refrigerant charge, performing a pressure test, evacuation, or a Thermostat Test that checks the functionality of a thermostat. After the technician completes the tests through utilization of the application 112, a report can be generated by the technician. As described above, the technician may generate screenshots of the GUI 110 of the application 112 and include such screenshots in the report. It is noted that in the GUI 110 depicted in FIG. 2, the GUI 110 fails to include a location-based identifier; hence, the technician can take screenshots of such GUI 110 and include those screenshots in reports for different locations (which is undesirable).

Returning to FIG. 1, the client computing device 102 also includes a location sensor 116 that is configured to output location data, where the location data is indicative of a current location of the client computing device 102. In an example, the location sensor 116 is a GPS sensor. Other examples of the location sensor 116 include an inertial sensor, a sensor configured to determine the location data based on received wireless signals, or the like. For instance, a sensor can receive nearby Wi-Fi network identifiers and/or Bluetooth beacon signals; the sensor can determine the location data based on the received signals. Thus, such a location sensor 116 can triangulate multiple signals in connection with determining the location data. According to another illustration, the location sensor 116 can read a near field communication (NFC) tag at the location to determine the location data.

Further, according to various examples, it is contemplated that the location data can be aggregated from more than one location sensor 116 to confirm physical presence at the current location. Thus, the client computing device 100 can include two or more of the above-noted types of location sensors 116 and/or two or more of a particular type of location sensor 116 (e.g., the client computing device 100 can include a GPS sensor and an inertial sensor, the client computing device 100 can include two (or more) GPS sensors, etc.). Following this example, location data from each of the more than one location sensor 116 can be aggregated and further employed as described herein. Additionally, inconsistencies between the location data from different locations sensors 116 can be flagged, can prevent accepting of an address or geolocation coordinates of the location based upon the location data as described herein, or the like. The below examples describing the client computing device 100 having one location sensor 116 thus can be extended to scenarios where the client computing device 100 includes more than one location sensor 116.

An example operation of the client computing device 102 is now set forth. The technician using the client computing device 102 has multiple appointments during a day, where the appointments include a first appointment at a first location and a second appointment at a second location. Upon arriving at the first location for the first appointment, the application 112 is initialized on the client computing device 102 by the technician. In an example, the client computing device 102 is a smart phone, and the application 112 can be initialized by the technician by selecting an icon that represents the application 112 displayed on the display 108. In another example, the client computing device 102 can initialize the application 112 in response to the location sensor outputting location data that indicates that the technician has reached the first location.

Upon being initialized, the application 112 is configured to obtain location data from the location sensor 116. The location data can be in any suitable format, including latitude/longitude coordinates, geocodes, physical addresses, etc. The application 112 then obtains a physical address for the first location based upon the location data. In an example, the application 112 is configured to convert the location data to a physical address. In another example, the application 112 is in communication with a plug-in (not shown) that determines the physical address based upon the location data. The application 112 sends the location data to the plug-in, which converts the location data to a physical address, and returns the physical address to the application 112.

Once the application 112 has a physical address that corresponds to the location of the client computing device 102, the GUI generator module 114 generates a visual element that displays the physical address to the technician and asks the technician to confirm that the physical address is the correct address (i.e., the physical address of the first location of the first appointment). If the physical address is incorrect, the GUI generator module 114 generates a text box, where the technician can manually enter a proposed address and submit the proposed address to the application 112.

After the proposed address is submitted, the application 112 transmits the proposed address to a location resolver module 118. The location resolver module 118 is configured to compare the proposed address provided by the technician to the location data output by the location sensor 116. When the location resolver module 118 determines that the proposed address is within a threshold range of the location data, the application 112 accepts the proposed address as the correct address for the first appointment. If the location resolver module 118 determines that the proposed address is not within the threshold range of the location data, the application 112 fails to accept the proposed address. In such case, the application 112 can notify the technician that the proposed address has not been accepted and can request that the technician set forth a different proposed address.

The threshold range mentioned above can depend on the technician and/or the information related to the appointment. Thus, the threshold range can be set based on a type of location at which the service is performed, an identity of the technician performing the service, a type of service being performed by the technician, a combination thereof, and so forth. For example, when the technician is an HVAC technician and the first appointment is at a residential home, the threshold range is 100 feet. In another example, if the technician is an electrician and the first appointment is a factory, the threshold range is 1,000 feet.

Once the application 112 accepts an address, the GUI generator module 114 generates the GUI 110 of the application 112, where the GUI 110 of the application 112 includes graphics related to the service performed at the first location and a location-based identifier 120. The location-based identifier 120 can be any kind of visual indicator that depicts location data related to the first location of the first appointment. In an example, the location-based identifier 120 is the physical address of the first location. In another example, the location-based identifier 120 is the location data provided by the location sensor 116. The location-based identifier 120 can also include the current time, the name of the first location, or any other kind of identifying information. The location-based identifier 120 can be located anywhere on the GUI 110 of the application 112. In some examples, the location-based identifier 120 is located at the bottom of the GUI 110 of the application 112. In other examples, the location-based identifier 120 is located at the top of the GUI 110 of the application 112.

According to various examples, the location data can be polled multiple times during an appointment at a corresponding location. For instance, the location data can be polled at a preset time interval during the appointment, continuously during the appointment, or the like (as opposed to the location data being polled once during the appointment at the corresponding location). Thus, the GUI generator module 114 can update the location-based identifier 120 included in the GUI 110 over time during the appointment. Accordingly, a screenshot of the GUI 110 of the application 112 can reflect live and recent location data during a service appointment.

While the description above has referenced determining location based upon output of a GPS sensor, other technologies are also contemplated. For example, the location sensor 116 can receive wireless signals from different base stations and can determine an approximate location of the client computing device 102 through triangulation. Following this example, the location sensor 116 can triangulate multiple signals in connection with determining the location data.

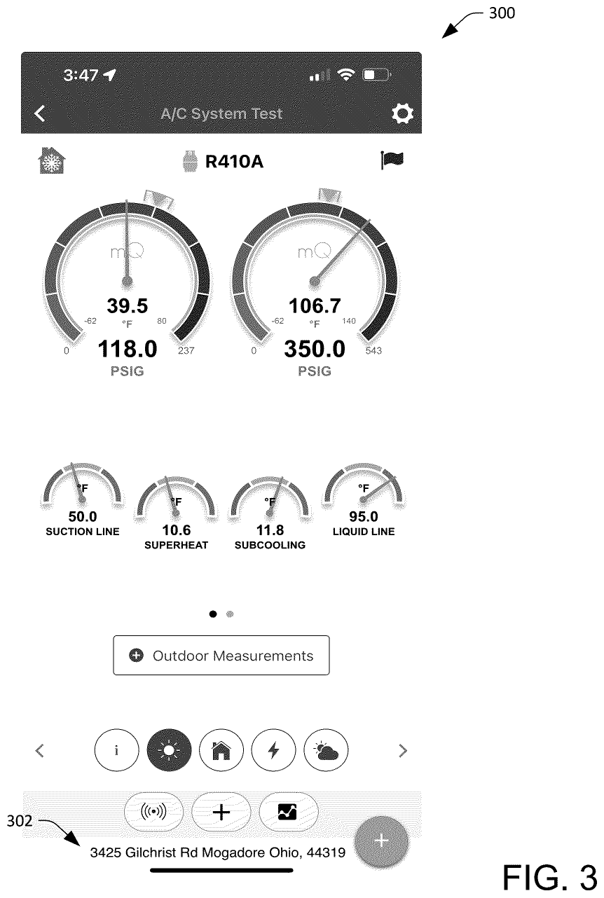

Briefly referring to FIG. 3, an example 300 of the GUI 110 of the application 112 with the location-based identifier 120 is shown. The location-based identifier 120 is located at the bottom of the GUI 110 of the application 112 (represented by callout 302). The location-based identifier 120 depicts the physical address of the first location.

As described above, the application 112 can be used to obtain measurements related to the first appointment at the first location. In an example, the application 112 is an HVAC application that obtains measurements of an HVAC system at the first location. The GUI 110 of the application 112 is shown on the display 108 of the client computing device 102, where the GUI 110 of the HVAC application 112 depicts measurements pertaining to the HVAC system (e.g., measurements related to pressure, temperature, etc.).

After measurements are obtained by way of the application 112, the technician can generate a report. The report can include measurements obtained by way of the application 112. For example, when the application 112 is an HVAC application that is used in connection with obtaining measurements related to pressure and temperature of refrigerant in an HVAC system, the report may include such measurements, as well as a screenshot of the GUI 110 depicting graphical detail related to such measurements.

In accordance with the technologies described herein, the location-based identifier 120 is included in the screenshot, where the location-based identifier 120 indicates that measurements were obtained at the first location. Additionally, when the screenshot is taken by the user, location data output by the location sensor 116 can be included in metadata that is assigned to the screenshot; hence, the location-based identifier 120 in the screenshot corresponds to the location data in the metadata assigned to the screenshot, thus facilitating prevention of a technician from including an improper screenshot (a screenshot captured at a different location) in the report.

Because the location-based identifier 120 is included in the GUI 110, which is then captured in the screenshot, the location-based identifier 120 cannot be removed from the screenshot or altered without editing the screenshot. An attempt to edit the screenshot through an image editing tool (such as cropping the screenshot, modifying the location-based identifier 120 through use of an image editing application, etc.) results in additional metadata being assigned to the screenshot that would indicate that the screenshot was subject to modification.

After including the screenshot in the report, the technician can continue to add more screenshots to the report or finalize the report. Because the GUI 110 of the application 112 includes the location-based identifier 120, any additional screenshots taken while the technician as at the first location will also have the location-based identifier 120. Accordingly, the application 112 can prevent report finalization when the metadata and the location-based identifier 120 (e.g., the address or the geolocation coordinates of the location) included in the GUI 110 do not match.

The GUI 110 of the application 112 includes the location-based identifier 120 until: 1) the technician sets forth an indication that the first appointment is complete; or 2) the application 112 receives location data from the location sensor 116 that indicates that the technician is no longer at the first location. In an example, the technician can close the application 112 after completing the first appointment. In another example, the application 112 can receive an indication from the technician that the first appointment has been completed.

After completing the first appointment, the technician travels to the second location for the second appointment. Because the screenshot generated by the client computing device 102 included in the report for the first appointment includes the location-based identifier 120, the technician is disincentivized from taking a new screenshot of such screenshot and including the new screenshot in a report for the second appointment (as the new screenshot will still show the location of the first appointment, and not the location of the second appointment). Accordingly, the technician repeats the process described above at the second location during the second appointment (i.e., a physical address of the second location for the second appointment is accepted by the application 112, the GUI generator module 114 causes the GUI 110 of the application 112 to include the location-based identifier 120 (which, for example, identifies the physical address of the second location), the application 112 is used to generate measurements, and a screenshot included in a report for the second appointment depicts the location-based identifier 120).

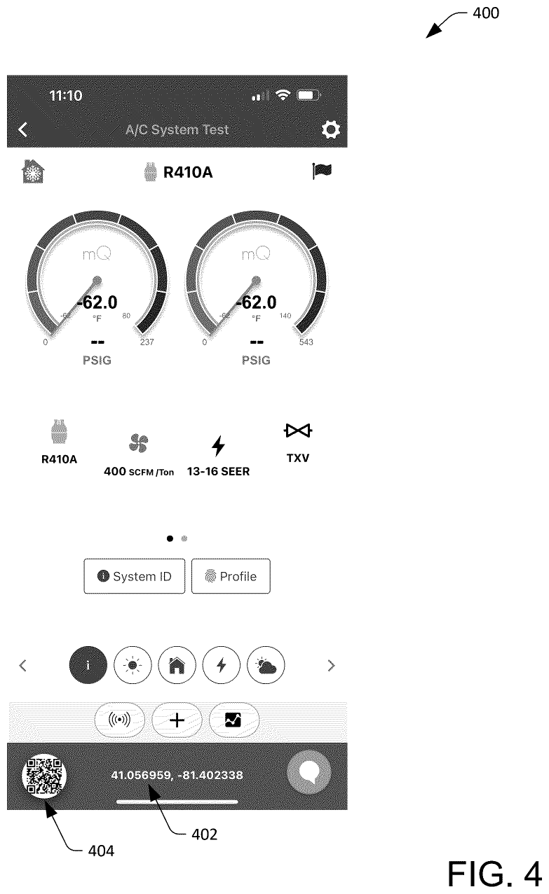

FIG. 4 illustrates another example 400 of the GUI 110 of the application 112 having the location-based identifier 120. In the example shown in FIG. 4, the location-based identifier 120 includes latitude/longitude coordinate values (represented by callout 402). The GUI 110 can be frequently updated to include latitude/longitude coordinate values (e.g., once a minute, once every 2 minutes, once every five minutes, etc.). Optionally, when the application 112 is unable to obtain location information output by the location sensor 116, the GUI generator module 114 can cause the location-based identifier 120 to indicate that the location has not been obtained. In addition, the GUI 110 includes a quick response (QR) code or other suitable barcode (collectively referred to as a barcode) (represented by callout 404). The barcode can encode a uniform resource locator (URL) that points to a webpage, where the webpage identifies the address where the service was performed. For example, the application 112 generates the barcode through use of a code library. Further, the barcode can encode geographic coordinates or the physical address where the service was performed (making it difficult to modify the GUI 110 to replace the barcode).

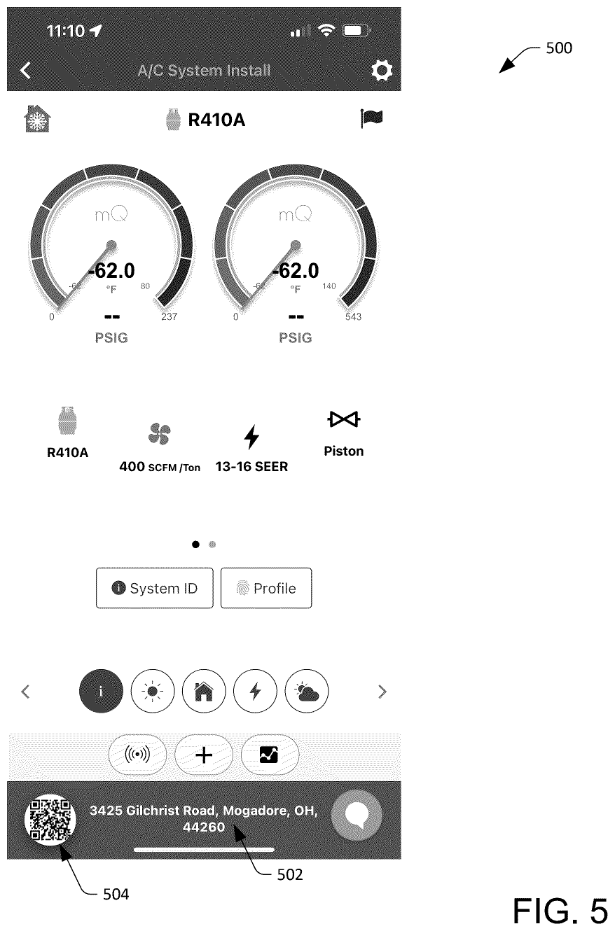

FIG. 5 depicts yet another example 500 of the GUI 110 of the application 112 having the location-based identifier 120. In the example 500 shown in FIG. 5, the GUI 110 includes a physical address as the location-based identifier 120 (represented by callout 502), and additionally includes a barcode that at least one of: 1) encodes a URL of a webpage that includes the physical address, or coordinates were the service was performed; or 2) encodes the physical address or coordinates themselves. The barcode is represented at callout 504.

Reference is again made to FIG. 1. In various embodiments, the client computing device 100 can be in communication with a server computing system (not shown). As described herein, the client computing device 100 can capture a screenshot of the GUI 110 including the location-based identifier 120. The client computing device 100 can transmit the screenshot and corresponding metadata to the server computing system. The server computing system can receive the screenshot of the GUI 110 and the metadata, and can verify consistency of the location data with expected service location. The server computing system can further approve or reject report submission based on the validation.

Moreover, in various embodiments, the client computing device 100 can be in communication with a computing device of a customer at the location of appointment. Again, the client computing device 100 can capture the screenshot of the GUI 110 including the location-based identifier 120. Moreover, the client computing device 100 can receive a digital acknowledgement from the computing device of the customer (or another type of interface). Finalization of a report including the screenshot of the GUI 110 can occur only upon receipt of the digital acknowledgement from the computing device of the customer; thus, two-party confirmation can be employed in such embodiments.

In various embodiments, it is contemplated that a screenshot of the GUI 110 can be analyzed post-capture to detect modification. For instance, the client computing device 100 and/or a server computing system in communication with the client computing device 100 can analyze the screenshot. Pursuant to an illustration, a hash mismatch or Exchangeable Image File Format (EXIT) alteration can be detected post-capture of the screenshot. Responsive to detecting the post-capture modification, an associated report that includes the screenshot can be automatically marked as invalid and/or an alert indicating tampering can be generated for the report.

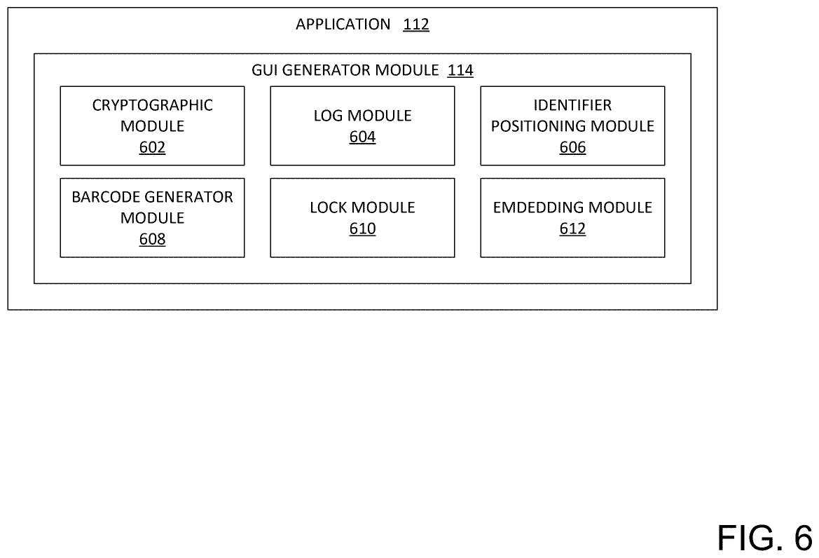

Referring now to FIG. 6, illustrated is the application 112 including the GUI generator module 114 according to various embodiments. The GUI generator module 114 can include one or more modules described below.

The GUI generator module 114 can include a cryptographic module 602. As described herein, a screenshot of the GUI 110 that includes the location-based identifier 120 generated by the GUI generator module 114 can be captured. Responsive to the screenshot being captured, the cryptographic module 602 can be configured to compute a cryptographic hash of the screenshot and associated metadata. The cryptographic hash can be stored locally on the client computing device 100 and/or transmitted to a remote server to enable tamper detection.

Moreover, the GUI generator module 114 can include a log module 604 configured to generate an immutable log recording each captured screenshot of the GUI 110 taken by the application 112. The log module 604 can include data such as a timestamp, location data (e.g., GPS data), a hash (e.g., generated by the cryptographic module 602), a combination thereof, with each screenshot in the log. Further, the log module 604 can cause the log to be cryptographically chained to mitigate undetected modification.

The GUI generator module 114 can further include an identifier positioning module 606 configured to dynamically alter a position of the location- based identifier 120 within the GUI 110 over time. For example, the GUI 110 can include a dynamically positioned watermark overlay that includes a current timestamp and the location-based identifier 120. The dynamically positioned watermark overlay can be transparent so as to not block other content of the GUI 110. The identifier positioning module 606 can shift the position of the watermark overlay on the GUI 110 at regular intervals to deter cropping or static reuse. Moreover, the watermark overlay can further include a device identifier of the client computing device 100.

The GUI generator module 114 can also include a barcode generator module 608 configured to generate a barcode for inclusion in the GUI 110 (e.g., the barcodes shown in FIGS. 4-5). The barcode generator module 608 can encode the current service location data and/or a unique service identifier as part of the barcode. Pursuant to an example where an NFC tag at the location is read, the barcode generator module 608 can further embed a secondary confirmation of presence based on the read NFC tag.

The GUI generator module 114 can further include a lock module 610 configured to disable functionality of the application 112 and/or lock a user account of the user of the application 112. For instance, the lock module 610 can disable functionality of the application 112 and/or lock the user account responsive to detecting inconsistencies in location data. The inconsistencies can include detected mock GPS data or emulated signals.

Moreover, the GUI generator module 114 can include an embedding module 612 configured to embed video or an image captured by a camera of the client computing device 100 in the GUI 110. The embedding module 612 thus can incorporate a live camera feed snapshot or image signature of a surrounding environment in the GUI 110 along with the location-based identifier 120 to deter offsite reuse or spoofing. For instance, the image embedded in the GUI 110 can depict a building with an address or a mailbox, which can be used an image signature for the location.

As noted above, in various embodiments, the GUI generator module 114 can include all of the modules 602-612 or a subset of the modules 602-612. In yet other embodiments, the GUI generator module 114 can lack the modules 602-612.

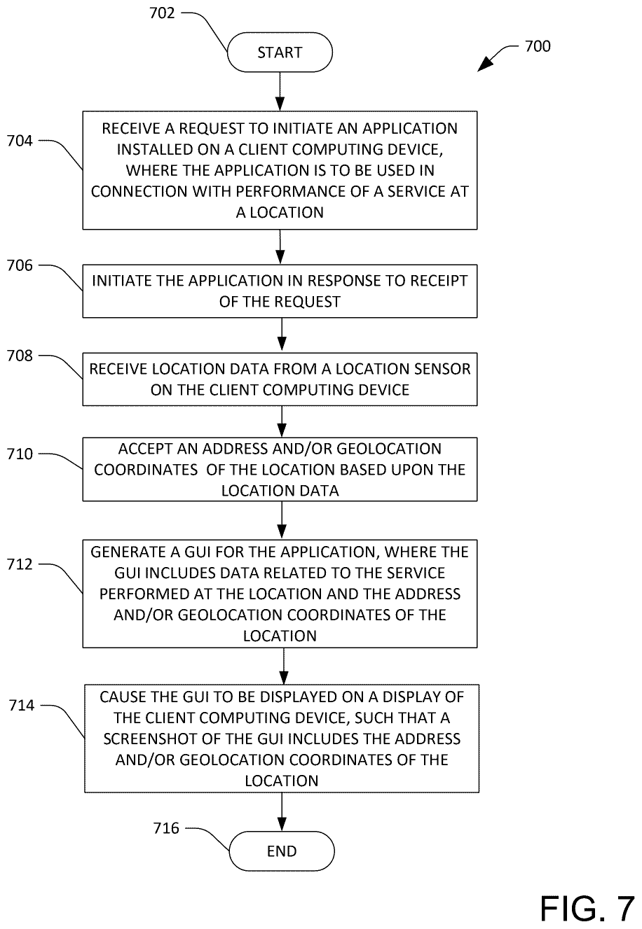

FIG. 7 illustrates a method 700 relating to generating a GUI for a service industry application. While the method is shown and described as being a series of acts that are performed in a sequence, it is to be understood and appreciated that the method is not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

The method 700 begins at 702, and at 704, a request to initiate an application installed on a client computing device is received, where the application is to be used in connection with performance of a service at a location that has an address and/or geolocation coordinates associated therewith (e.g., a service industry application). At 706, the application is initiated in response to receipt of the request. At 708, location data from a location sensor on the client computing device is received. At 710, the address and/or geolocation coordinates of the location is accepted based upon the location data. At 712, a GUI is generated for the application, where the GUI includes data related to the service performed at the location and the address and/or geolocation coordinates of the location. At 714, the GUI is displayed on a display of the client computing device, such that a screenshot of the GUI includes the address and/or geolocation coordinates of the location. The method completes at 716.

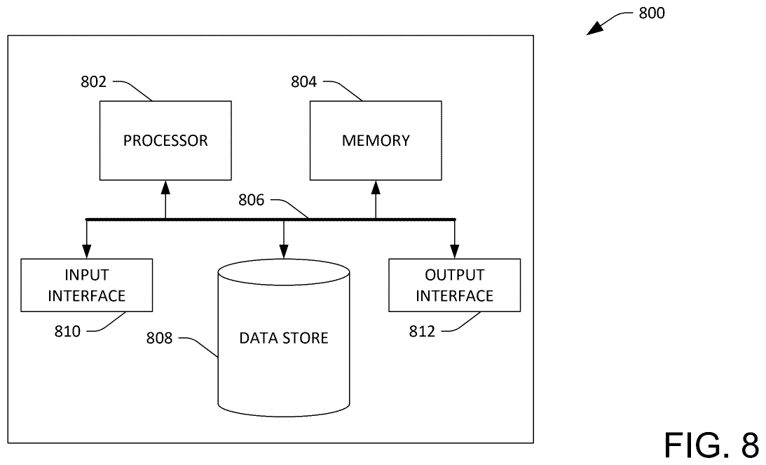

Referring now to FIG. 8, a high-level illustration of an exemplary computing device 800 that can be used in accordance with the systems and methodologies disclosed herein is illustrated. For instance, the computing device 800 can be a client computing device that is employed by a user. The computing device 800 includes at least one processor 802 that executes instructions that are stored in a memory 804. The instructions may be, for instance, instructions for implementing functionality described as being carried out by one or more components discussed above or instructions for implementing one or more of the methods described above. The processor 802 may access the memory 804 by way of a system bus 806. In addition to storing executable instructions, the memory 804 may also store the location of the client computing device, computer-implemented applications, etc.

The computing device 800 additionally includes a data store 808 that is accessible by the processor 802 by way of the system bus 806. The data store 808 may include executable instructions, prompts, etc. The computing device 800 also includes an input interface 810 that allows external devices to communicate with the computing device 800. For instance, the input interface 810 may be used to receive instructions from an external computer device, from a user, etc. The computing device 800 also includes an output interface 812 that interfaces the computing device 800 with one or more external devices. For example, the computing device 800 may display text, images, etc. by way of the output interface 812.

It is contemplated that the external devices that communicate with the computing device 800 via the input interface 810 and the output interface 812 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 800 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 800 may be a distributed system. Thus, for instance, several devices may be in communication by way of a network connection and may collectively perform tasks described as being performed by the computing device 800.

Various functions described herein can be implemented in hardware, software, or any combination thereof. If implemented in software, the functions can be stored on or transmitted over as one or more instructions or code on a computer- readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium.

Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A client computing device, comprising:
a processor; and
memory storing instructions that, when executed by the processor, cause the processor to perform acts comprising:
receiving a request to initiate an application installed on the client computing device, where the application is to be used in connection with performance of a service at a location that has at least one of an address or geolocation coordinates assigned thereto;
initiating the application in response to receipt of the request;
receiving location data from a location sensor on the client computing device;
accepting the at least one of the address or the geolocation coordinates of the location based upon the location data;
generating a graphical user interface (GUI) for the application, where the GUI includes data related to the service performed at the location and the at least one of the address or the geolocation coordinates of the location; and
causing the GUI to be displayed on a display of the client computing device, such that a screenshot of the GUI includes the address of the location.

2. The client computing device of claim 1, wherein the location sensor is GPS sensor.

3. The client computing device of claim 1, wherein the location sensor triangulates multiple signals in connection with determining the location data.

4. The client computing device of claim 1, wherein the GUI further includes a barcode that encodes a uniform resource locator (URL) that points to a webpage, wherein the webpage includes at least one of the address or the geolocation coordinates of the location.

5. The client computing device of claim 1, wherein the GUI further includes a barcode that encodes at least one of the address or the geographic coordinates of the location.

6. The client computing device of claim 1, wherein the location data is included as metadata assigned to the screenshot, and wherein the application prevents report finalization when the metadata and the at least one of the address or the geolocation coordinates of the location included in the GUI do not match.

7. The client computing device of claim 1, wherein the application is a heating, ventilation, and air conditioning (HVAC) application that analyzes characteristics of an HVAC system, wherein the characteristics comprise at least one of a pressure of a refrigerant in the HVAC system or a temperature of the refrigerant in the HVAC system.

8. The client computing device of claim 1, the acts further comprising:
causing the at least one of the address or the geolocation coordinates of the location to be displayed on the display of the client computing device;
wherein accepting the at least one of the address or the geolocation coordinates of the location based upon the location data comprises receiving confirmation that the at least one of the address or the geolocation coordinates displayed on the display matches the location at which the service is performed.

9. The client computing device of claim 1, the acts further comprising:
causing the at least one of the address or the geolocation coordinates of the location to be displayed on the display of the client computing device;
receiving a manually-entered physical address when the at least one of the address or the geolocation coordinates of the location displayed on the display is incorrect; and
comparing the manually-entered physical address with the location data;
wherein accepting the at least one of the address or the geolocation coordinates of the location based upon the location data comprises accepting the manually-entered physical address for inclusion in the GUI when the manually-entered physical address is within a threshold range of the location data.

10. The client computing device of claim 9, the acts further comprising:
generating a notification indicative of the manually-entered physical address not being accepted when the manually-entered physical address is not within the threshold range of the location data.

11. The client computing device of claim 9, wherein the threshold range is set based on a type of location at which the service is performed.

12. A method for generating a graphical user interface (GUI) for an application installed on a client computing device, comprising:
receiving a request to initiate the application, where the application is to be used in connection with performance of a service at a location that has at least one of an address or geolocation coordinates assigned thereto;
initiating the application in response to receipt of the request;
receiving location data from a location sensor on the client computing device;
accepting the at least one of the address or the geolocation coordinates of the location based upon the location data;
generating the GUI for the application, where the GUI includes data related to the service performed at the location and the at least one of the address or the geolocation coordinates of the location; and
causing the GUI to be displayed on a display of the client computing device, such that a screenshot of the GUI includes the address of the location.

13. The method of claim 12, wherein the location sensor is GPS sensor.

14. The method of claim 12, wherein the GUI further includes a barcode that encodes a uniform resource locator (URL) that points to a webpage, wherein the webpage includes at least one of the address or the geolocation coordinates of the location.

15. The method of claim 12, wherein the GUI further includes a barcode that encodes at least one of the address or the geographic coordinates of the location.

16. The method of claim 12, wherein the location data is included as metadata assigned to the screenshot, and wherein the method further comprises:
preventing report finalization when the metadata and the at least one of the address or the geolocation coordinates of the location included in the GUI do not match.

17. The method of claim 12, wherein the application is a heating, ventilation, and air conditioning (HVAC) application that analyzes characteristics of an HVAC system, wherein the characteristics comprise at least one of a pressure of a refrigerant in the HVAC system or a temperature of the refrigerant in the HVAC system.

18. The method of claim 12, further comprising:
causing the at least one of the address or the geolocation coordinates of the location to be displayed on the display of the client computing device;
wherein accepting the at least one of the address or the geolocation coordinates of the location based upon the location data comprises receiving confirmation that the at least one of the address or the geolocation coordinates displayed on the display matches the location at which the service is performed.

19. The method of claim 12, further comprising:
causing the at least one of the address or the geolocation coordinates of the location to be displayed on the display of the client computing device;
receiving a manually-entered physical address when the at least one of the address or the geolocation coordinates of the location displayed on the display is incorrect; and
comparing the manually-entered physical address with the location data;
wherein accepting the at least one of the address or the geolocation coordinates of the location based upon the location data comprises accepting the manually-entered physical address for inclusion in the GUI when the manually-entered physical address is within a threshold range of the location data.

20. The method of claim 19. further comprising:
generating a notification indicative of the manually-entered physical address not being accepted when the manually-entered physical address is not within the threshold range of the location data.
